(19) United States
(12) Patent Application Publication
(10) Pub. No.: US 2013/0106995 A1
(43) Pub. Date: May 2, 2013

(54) DISPLAY APPARATUS FOR VEHICLE AND METHOD OF CONTROLLING THE SAME

(71) Applicants: Hae Jin Jeon, Gyunggi-do (KR); In Taek Song, Gyunggi-do (KR)

(72) Inventors: Hae Jin Jeon, Gyunggi-do (KR); In Taek Song, Gyunggi-do (KR)

(73) Assignee: SAMSUNG ELECTRO-MECHANICS CO., LTD., Gyunggi-do (KR)

(21) Appl. No.: 13/350,994

(22) Filed: Jan. 16, 2012

(30) Foreign Application Priority Data
Oct. 31, 2011 (KR) 1020110112507

(51) Int. Cl. G09G 5/00; H04N 13/00

(52) U.S. Cl. 348/43; 345/156; 348/E13.003

(57) ABSTRACT

Disclosed herein are a display apparatus for a vehicle and a method of controlling the same. The display apparatus includes: a user interface; a sensing unit providing approaching person information; a display unit; and a controlling unit controlling the display screen of the display unit based on an input through the user interface and changing and providing usable menus according to an approaching person based on the approaching person information provided through the sensing unit when the movement of the vehicle is sensed by the sensing unit.

### CROSS REFERENCE TO RELATED APPLICATION

This application claims the benefit of Korean Patent Application No. 10-2011-0112507, filed on Oct. 31, 2011, entitled “Display Apparatus for Vehicle and Control Method thereof”, which is hereby incorporated by reference in its entirety into this application.

### BACKGROUND OF THE INVENTION

1. Technical Field

The present invention relates to a display apparatus for a vehicle and a method of controlling the same.

2. Description of the Related Art

The method of obtaining information in a moving vehicle according to the prior art was to listen to or view radio frequency and terrestrial broadcasting by mounting a radio receiver or a television (TV) receiver for a vehicle in a center fascia panel of the vehicle.

Since these receivers target simple broadcasting reception, a range that may be selected by users has also been limited to the broadcasting reception.

In accordance with the development of the information technology, a technology of providing various application services to a driver of a vehicle by applying a mobile communication technology and a position tracking technology to the vehicle has appeared.

Furthermore, in accordance with the opening of a digital broadcasting station and the increases in functions of a portable terminal, various display apparatuses for a vehicle capable of viewing digital multimedia broadcasting (DMB) and searching positional information through a navigation system using a global positioning system (GPS) within a moving vehicle have been developed.

The display apparatus for a vehicle is not provided as a separate apparatus; rather, a general portable terminal apparatus, for example, a personal digital assistant (PDA), a mobile phone, a navigation terminal apparatus, is used as the display apparatus for a vehicle, and display contents of the display apparatus for a vehicle are displayed through a display panel provided in the terminal apparatus.

In the display apparatus for a vehicle as described above, a driver driving a car, or the like, in which the display apparatus for a vehicle is mounted may easily view broadcasting or obtain positional information anytime and anywhere using the display apparatus for a vehicle mounted in the vehicle.

Generally, in the case in which the vehicle is driven at a low speed due to traffic congestion, or the like, even though the driver manipulates the display apparatus for a vehicle, a large problem is not generated in safe driving. However, in the case in which the driver manipulates the display apparatus for a vehicle while driving the vehicle at a high speed, a large problem is generated in the safety driving.

That is, in the case in which the driver manipulates the display apparatus for a vehicle while driving the vehicle, concentration on driving is deteriorated, similar to the case of using a mobile phone during driving. Therefore, in the case in which the driver manipulates the display apparatus for a vehicle while driving the vehicle, a large problem such as a person accident may be generated.

### PRIOR ART DOCUMENT

### Patent Document

(Patent Document 1) U.S. Pat. No. 6,029,110

### SUMMARY OF THE INVENTION

The present invention has been made in an effort to provide a display apparatus for a vehicle capable of limiting the manipulation by a driver by providing different control menus to the driver and an assistant seat passenger when a car is being driven, and a method of controlling the same.

According to a preferred embodiment of the present invention, there is provided a display apparatus for a vehicle, the display apparatus including: a user interface processing a user input; a sensing unit sensing movement of the vehicle to output a sensed result and providing approaching person information in the case in which a passenger approaches the user interface within a predetermined distance; a display unit providing a display screen; and a controlling unit controlling the display screen of the display unit based on an input through the user interface and changing and providing usable menus according to an approaching person based on the approaching person information provided through the sensing unit when the movement of the vehicle is sensed by the sensing unit.

The sensing unit may include: a speed sensor measuring and providing a speed of the vehicle in the case in which the vehicle moves; and a distance sensing sensor providing the approaching person information when the passenger approaches the user interface within the predetermined distance.

The distance sensing sensor may include: a time of flight (TOF) camera measuring and outputting a distance between the user interface and an object, obtaining a 2-dimensional (2D) RGB image of the object, and synthesizing information on the measured distance with each pixel of the obtained 2D RGB image to generate and output a 3-dimensional (3D) image; an approach determinator confirming whether an approaching person approaching the user interface within the predetermined distance was generated using a change in the distance between the user interface and the object output from the TOF camera; and an approaching person determinator confirming a position in the 3D image generated in the TOF camera to determine whether the approaching person is a driver or an assistant seat passenger, thereby providing corresponding approaching person information, in the case in which the generation of the approaching person is confirmed in the approach determinator.

The display apparatus may further include a digital multimedia broadcasting (DMB) receiving unit receiving DMB broadcasting signals, wherein the controlling unit provides information received through the DMB receiving unit to the display unit.

The display apparatus may further include: a global positioning system (GPS) receiving unit receiving information on a current position; and a multimedia managing unit managing storage and reproduction of multimedia information, wherein the controlling unit generates a display content based on information received through the GPS receiving unit and information stored in the multimedia managing unit to provide a display screen to the display unit.

The controlling unit may limit the usable menus when the movement of the vehicle is sensed by the sensing unit and then release some or all of the limited menus when an assistant seat passenger approaches the user interface within the predetermined distance based on the approaching person information provided through the sensing unit.

The controlling unit may limit the usable menus when the movement of the vehicle is sensed by the sensing unit and then limit some or all of the usable menus when a driver approaches the user interface within the predetermined distance based on the approaching person information provided through the sensing unit.

According to another preferred embodiment of the present invention, there is provided a method of controlling a display apparatus for a vehicle, the method including: (A) providing, in a controlling unit, a display screen through a display unit in the case in which viewing is requested; and (B) changing and providing, in the controlling unit, usable menus according to an approaching person based on approaching person information provided through a sensing unit in the case in which movement of the vehicle is sensed by the sensing unit.

Step A may include: (A1) determining, in the controlling unit, whether or not DMB broadcasting viewing is requested; (A2) processing, in the controlling unit, DMB broadcasting data received by a DMB receiving unit in the case in which the DMB broadcasting viewing is requested as a result of the determination; and (A3) providing, in the controlling unit, the processed DMB broadcasting data as the display screen through the display unit.

Step (B) may include: (B1) limiting, in the controlling unit, the usable menus when the movement of the vehicle is sensed by the sensing unit; (B2) receiving, in the controlling unit, the approaching person information on an approaching person approaching a user interface within a predetermined distance through the sensing unit; and (B3) releasing, in the controlling unit, the limitation of the menus in the case in which the approaching person information provided through the sensing unit indicates that the approaching person is an assistant seat passenger.

Step (B) may include: (B1′) monitoring, in the controlling unit, approach of a passenger to a user interface when the movement of the vehicle is sensed by the sensing unit; (B2′) receiving, in the controlling unit, the approaching person information on an approaching person approaching a user interface within a predetermined distance through the sensing unit; and (B3′) limiting, in the controlling unit, the usable menus in the case in which the approaching person information provided through the sensing unit indicates that the approaching person is a driver.

A process of providing, in the sensing unit, the approaching person information of step B may include: (B1″) measuring a distance between a user interface and an object using a TOF camera; (B2″) obtaining a 2D RGB image of the object using the TOF camera; (B3″) synthesizing, in the TOF camera, information on the measured distance with each pixel of the obtained 2D RGB image to generate a 3D image; (B4″) confirming, in an approach determinator, whether the approaching person approaching the user interface within a predetermined distance was generated using a change in brightness of the 3D image generated in the TOF camera; and (B5″) confirming, in an approaching person determinator, a position in the 3D image generated in the TOF camera to determine whether the approaching person is a driver or an assistant seat passenger, thereby providing corresponding approaching person information, in the case in which the generation of the approaching person is confirmed in the approach determinator.

### BRIEF DESCRIPTION OF THE DRAWINGS

FIG. 1 is a diagram showing a configuration of a display apparatus for a vehicle according to a preferred embodiment of the present invention;

FIG. 2 is a diagram showing an example of a menu limiting screen provided to a driver during driving by the display apparatus for a vehicle of FIG. 1;

FIG. 3 is a diagram showing an example of a screen provided to a assistant seat passenger during driving by the display apparatus for a vehicle of FIG. 1;

FIG. 4 is a diagram showing a configuration of a distance sensing sensor of FIG. 1;

FIG. 5 is a diagram describing 3-dimensional (3D) image synthesis;

FIG. 6 is a flow chart showing a method of controlling a display apparatus for a vehicle according to the preferred embodiment of the present invention; and

FIG. 7 is a flow chart showing a process of determining whether an assistant seat passenger has approached a user interface of FIG. 6.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

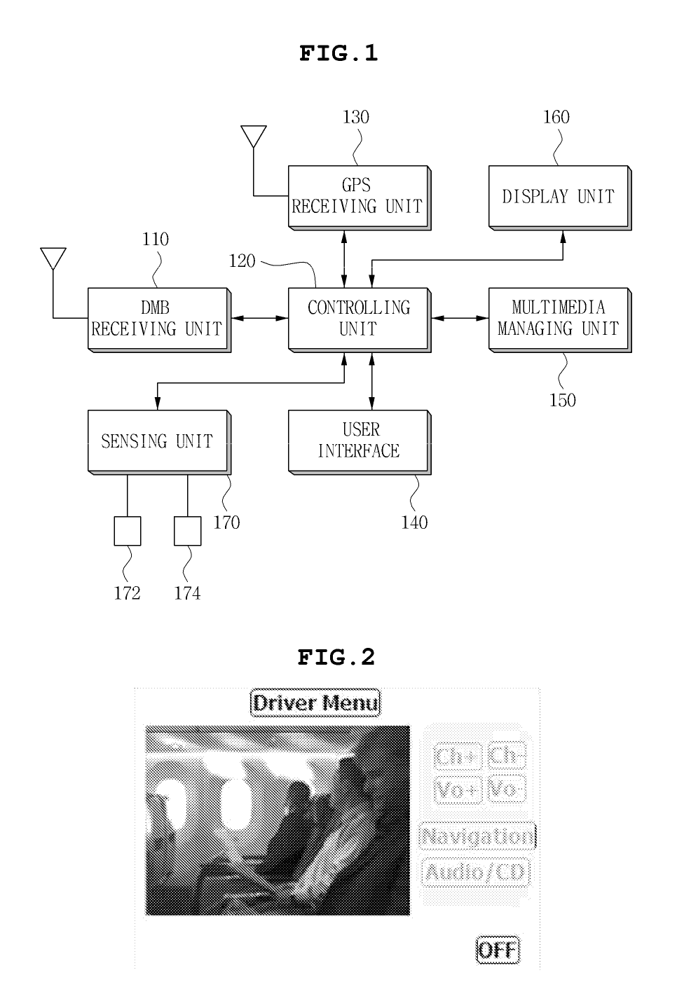

FIG. 1 is a diagram showing a configuration of a display apparatus for a vehicle according to a preferred embodiment of the present invention.

Referring to FIG. 1, the display apparatus for a vehicle according to the preferred embodiment of the present invention is configured to include a digital multimedia broadcasting (DMB) receiving unit 110 receiving DMB broadcasting signals, a global positioning system (GPS) receiving unit 130 receiving information on a current position, a multimedia managing unit 150 managing storage and reproduction of the multimedia information, a sensing unit 170 sensing operation of the vehicle and operation of a passenger, a user interface 140 processing a user input, a display unit 160 providing a display screen, and a controlling unit 120 generating display contents based on information received through the DMB receiving unit 110 and the GPS receiving unit 130 and information stored in the multimedia managing unit 150 to output the display contents as the display screen and controlling the screen provided in the display screen or limiting a usable menu based on inputs through the sensing unit 170 or the user interface 140.

Each of the components will be described in detail.

First, each of the DMB receiving unit 110 and the GPs receiving unit 130, which is based on a general technical content, may include an antenna for receiving a corresponding signal.

Through the antenna, the DMB receiving unit 110 receives and recovers DMB broadcasting service signals for each channel to output broadcasting information on a selected channel and the GPS receiving unit 130 receives current latitude and longitude data of the vehicle by linkage to a mobile communication base station to output information on a current position of the vehicle.

A channel associated with the information received by the DMB receiving unit 110 may be selected according to inputs of users through the user interface 140.

In addition, the multimedia managing unit 150 may include a storage device, or the like, such as a read only memory (ROM), random access memory (RAM), a hard disk, or the like, for storing various multimedia information therein, and channel information and broadcasting reception information of the DMB receiving unit 110 and a map database (DB) of the GPS receiving unit 130 may be stored in the storage device.

In addition, the multimedia managing unit 150 includes a universal serial bus (USB) port for connection to an external medium, thereby making it possible to obtain and store multimedia information from the external medium.

In addition, the user interface 140, which is a unit obtaining and outputting the input of the user, may be a plurality of buttons, dials, or the like, and may be formed of a touch screen sensor provided on the display unit 160 to be described as needed.

Therefore, the DMB reception information, the GPS reception information, or the multimedia reproduction information may be processed by the controlling unit 120 and displayed on the display unit 160 based on the input information of the user through the user interface 140.

In addition, the display unit 160 displays the DMB reception information, the GPS reception information, or the multimedia reproduction information to the user.

As this display unit 160, a flat panel display (FPD) device such as a liquid crystal display (LCD), an organic electro luminescent display (ELD), a plasma display panel (PDP), or the like, or a miracle glass and a projection may be used.

Further, the controlling unit 120 may be a unit controlling the general operation of the display apparatus for a vehicle, for example, a unit signal-processing the information provided by the DMB receiving unit 110, the GPS receiving unit 130, and the multimedia managing unit 150 to output the information to the display unit 160 based on the input of the user interface 140 or the sensing unit 170. As the controlling unit 120, a arithmetic and logic unit such as a micom, or the like, having a predetermined algorithm embedded therein may be used.

In the case in which movement of the vehicle is sensed by a sensing unit 170 to be described below and the vehicle is driven at a speed more than a predetermined speed, the controlling unit 120 limits the use of specific menus.

In this case, when approach of the assistant seat passenger to the user interface 140 is confirmed through the sensing unit 170 in a state in which the use of the specific menus is limited, the controlling unit 120 releases some or all of the limited menus to allow some or all of the limited menus to be usable.

Alternately, in the case in which the movement of the vehicle is sensed through the sensing unit 170 and the vehicle is driven at a speed more than a predetermined speed, the controlling unit 120 may also maintain a state in which all menus may be used and limit the use of some or all of the menus when approach of the driver to the user interface 140 is confirmed through the sensing unit 170.

Finally, the sensing unit 170 senses the operation of the vehicle and the operation of the passenger to transfer sensing result to the controlling unit 120.

To this end, the sensing unit 170 includes a speed sensor 172 and a distance sensing sensor 174 that are in charge of different roles.

The speed sensor 172 measures a movement speed of the vehicle in order to determine whether or not the vehicle has moved to thereby provide the measured movement speed to the controlling unit 120.

A typical example of this speed sensor 172 includes an inertial sensor.

The inertial sensor calculates a speed of a moving object using a gyroscope (hereinafter, referred to as a ‘gyro’) sensing rotational movement of the moving object and an accelerometer sensing linear movement thereof. Particularly, the speed of the vehicle may be calculated using both of velocity information calculated from acceleration measured by the accelerometer and movement direction information measured by the gyro.

Next, the distance sensing sensor 174 senses the operation of the passenger and provides approaching person information, that is, information on whether the passenger is a driver or an assistant seat passenger, to the controlling unit 120 in the case in which a portion of a body of the passenger approaches the user interface 140 within a predetermined distance (for example, within 100 cm).

An example of a detailed configuration of the distance sensing sensor 174 operated as described above is shown in FIG. 4. A configuration and an operation of the distance sensing sensor 174 will be described below.

Hereinafter, an operation of the display apparatus for a vehicle according to the preferred embodiment of the present invention will be described in detail.

First, when the display apparatus for a vehicle is operated, the DMB broadcasting reception information, the position information, or the multimedia information received by the DMB receiving unit 110 and the GPS receiving unit 130 are displayed through the display screen of the display unit 160 through the controlling unit 120.

Here, in the case in which the vehicle moves, the speed sensor 172 of the sensing unit 170 senses the movement speed of the vehicle to provide the sensed movement speed to the controlling unit 120.

Here, when it is determined based on information sensed by the speed sensor 172 that the vehicle has moved at a speed more than a predetermined speed, the controlling unit 120 limits the use menus other than a specific menu (for example, an on/off menu) by the passenger through the user interface 140.

In addition, the controlling unit 120 controls the multimedia managing unit 150 to provide a menu limiting screen indicating that the use of menus other than the specific menu has been limited to the display unit 160.

An example of the screen provided through the display unit 160 is shown in FIG. 2. In FIG. 2, the use of a channel selection function, a volume control function, an audio/compact disk (CD) selection function is limited, and only an on/off menu may be used.

Meanwhile, in this state, in the case in which any one of the driver or the assistant seat passenger approaches the user interface 140 in order to manipulate the menu of the display apparatus for a vehicle using his/her hand, or the like, while the vehicle is moving, the distance sensing sensor 174 determines whether the driver has approached the user interface 140 and the assistant seat passenger has approached the user interface 140 to provide the determination result to the controlling unit 120.

In the case in which the driver approaches the user interface 140, the controlling unit 120 may maintain the menu limiting state, and in the case in which the assistant seat passenger approaches the user interface 140, the controlling unit 120 may release the limitation of the menu to allow the assistant seat passenger to use several usable menus.

Even in the case in which the assistant seat passenger approaches the user interface 140, the controlling unit 120 may release the limitation of some menus but allow other menus to be maintained in the limited state.

Here, the controlling unit 120 controls the multimedia managing unit 150 to provide a screen indicating that all menus may be used to the display unit 160.

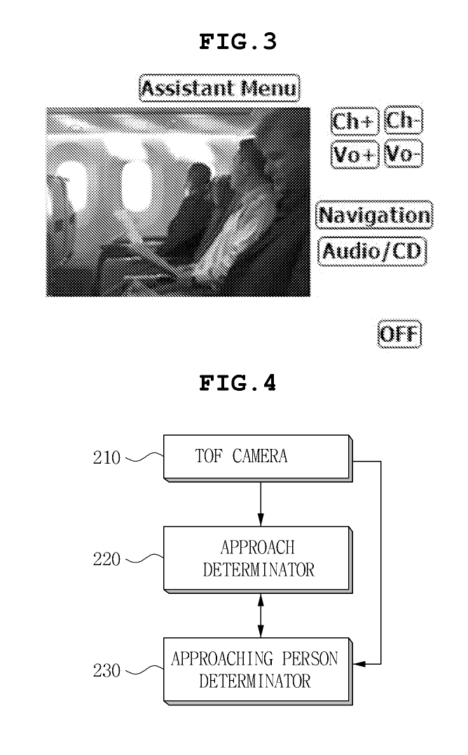

An example of the screen provided through the display unit 160 is shown in FIG. 3. In FIG. 3, functions of which the use by the driver is limited, such as a channel selection function, a volume control function, an audio/compact disk (CD) selection function, and the like, may be used.

In the case in which it is sensed through the distance sensing sensor 174 of the sensing unit 170 that the assistant seat passenger is spaced apart from the user interface 140 by a predetermined distance, the controlling unit 120 again limits the user of the menus.

As described above, according to the preferred embodiment of the present invention, the manipulation of the display apparatus for a vehicle by the driver is limited when the vehicle is being driven, such that a safety accident caused by manipulating the apparatus at the time of driving is prevented in advance, thereby making it possible to remove a risk of a person accident.

In addition, according to the preferred embodiment of the present invention, it is possible to increase convenience of the user by allowing the assistant seat passenger to manipulate the apparatus when the vehicle is being driven.

FIG. 4 is a diagram showing a configuration of a distance sensing sensor of FIG. 1.

Referring to FIG. 4, the distance sensing sensor of FIG. 1 is configured to include a time of flight (TOF) camera 210, an approach determinator 220, and an approaching person determinator 230.

The TOF camera 210 measures a distance between the user interface and an object around the user interface. Here, TOF indicates a time required for a short light pulse to be transmitted from a camera module and return to the camera module by being reflected on an object after the short light pulse contacts the object. That is, the TOF may be calculated as a difference value between a time t1 at which light is discharged from the camera module and a time t2 at which the light is detected after being reflected on the object and may be represented by the following Equation 1.

TOF=t2−t1 Equation 1

In addition, a distance d of the object measured through the TOF camera 210 may be represented by the following Equation 2.

d=(c*TOF)/2 Equation 2

Where C means a speed of light.

In addition, the TOF camera 210 obtains a 2-dimensional (2D) RGB image of the object and synthesizes the measured distance information with each pixel of the obtained 2D RGB image to generate and output a 3-dimensional (3D) image.

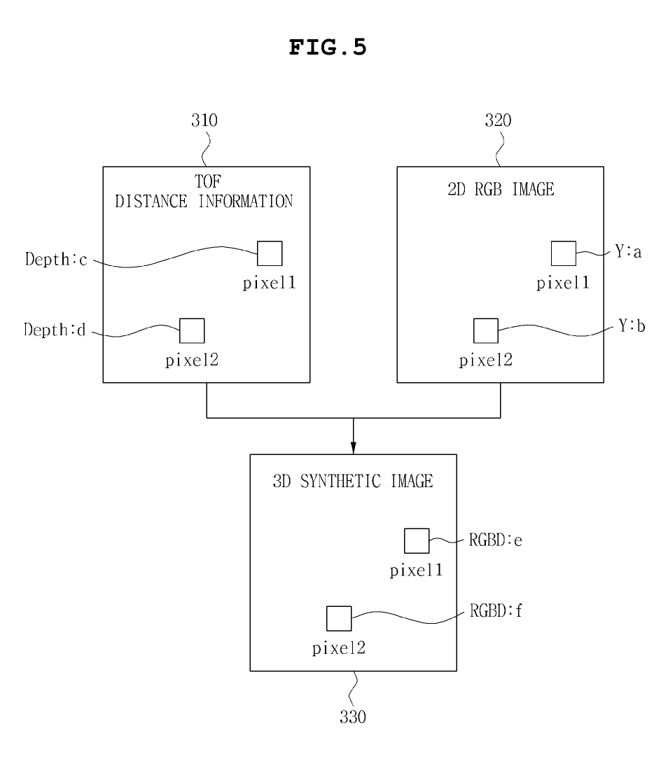

The syntheses of the 3D image will be described in more detail with reference to FIG. 5. In the case in which a distance of pixel 1 from the user interface is c, a distance of pixel 2 from the user interface is d, and d is larger than c, that is, pixel 1 is closer to the user interface than pixel 2, based on TOF distance information 310, the TOF camera 210, a, which is a contrast value of pixel 1, is raised from its original value by a predetermined value and b, which is a contrast value of pixel 2, is lowered from its original value by a predetermined value, in a 2D RGB image 320.

A contrast value of pixel 1 of the 2D RGBD synthetic image 330 obtained through the above-mentioned process becomes e, and a contrast value of pixel 2 thereof becomes f. The 2D RGBD synthetic image 330 as described above represents an effect that a close object becomes relatively bright and a distant object becomes relatively dark, such that it becomes a 3D image in which a space and a position may be inferred.

That is, in the case in which a distance is close, a contrast value of a pixel is raised from an original contrast value of the pixel by a predetermined value, and in the case in which a distance is distant, a contrast value of a pixel is lowered from an original contrast value of the pixel by a predetermined value, such that a final RGBD image having color (RGB) values and a depth (D) value is completed.

Next, the approach determinator 220 determines that the passenger approaches the user interface in order to manipulate the menus included in the user interface in the case in which a change is present in the distance of the object measured through the TOF camera 210 and the distance is gradually reduced and transmits the determination result to the approaching person determinator 230.

Then, the approaching person determinator 230 determines a position at which a brightness change is generated in the 3D image input from the TOF camera 210 to determine whether the approaching person is the driver or the assistant seat passenger and provides the determination result to the controlling unit.

Meanwhile, although the preferred embodiment of the present invention has described a method of confirming that the assistant seat passenger approaches the user interface, in the case in which the assistant seat passenger is spaced apart from the user interface, a spaced degree and distance may be determined by confirming whether or not brightness was gradually reduced.

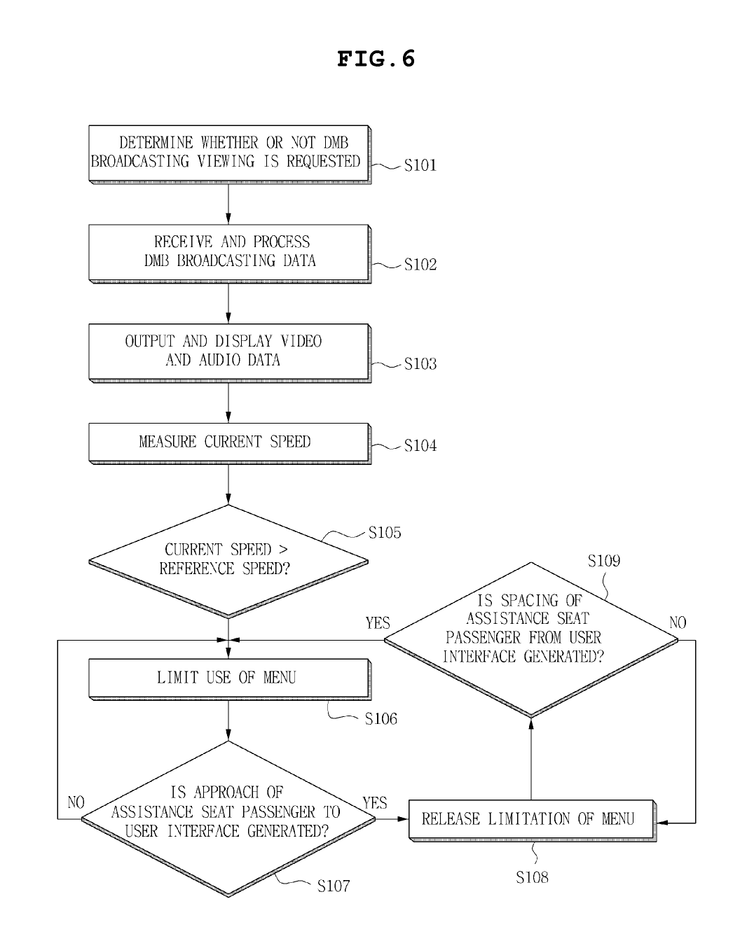

FIG. 6 is a flow chart showing a method of controlling a display apparatus for a vehicle according to the preferred embodiment of the present invention.

Referring to FIG. 6, in the method of controlling a display apparatus for a vehicle according to the preferred embodiment of the present invention, a controlling unit first determines whether or not DMB broadcasting viewing was requested by a passenger through a user interface (S101).

When it is determined that the DMB broadcasting viewing is requested by the passenger, the controlling unit drives a DMB receiving unit to receive DMB broadcasting data on a selected channel and processes the received DMB broadcasting data so as to be able to be displayed (S102), and outputs and displays each of video and audio data onto a display unit (S103).

Here, a method of processing the DMB broadcasting data is the same as a general method of processing DMB broadcasting data. Therefore, a detailed description thereof will be omitted.

Then, the controlling unit receives a current speed measured by a speed sensor of a sensing unit (S104), and compares the current speed with a preset reference speed (S105).

Here, the speed sensor performs a sensing operation simultaneously with turn-on of power of the display apparatus for a vehicle to continuously or periodically provide sensed values to the controlling unit of FIG. 1. An example in which the sensing operation is not performed after the DMB broadcasting data is output as described above is only a sequence for describing an operation process in the flow chart of FIG. 6.

In the case in which the current speed of the vehicle is higher than the preset reference speed as a determination result of whether the current speed of the vehicle sensed by the speed sensor of the sensing unit is higher than the present reference speed in operation (S105), the controlling unit limits the use of menus (S106).

Next, the controlling unit monitors approach of an assistant seat passenger to the user interface through a distance sensing sensor of the sensing unit (S107), and then releases some or all of the limited menus to allow the assistant seat passenger to use the released menus when the assistant seat passenger approaches the user interface (S108).

The controlling unit again limits the use of the menus (S106) when it is sensed by the distance sensing sensor of the sensing unit that the assistant seat passenger is spaced apart from the user interface by a predetermined distance (S109).

As described above, according to the preferred embodiment of the present invention, the manipulation of the display apparatus for a vehicle by the driver is limited when the vehicle is being driven, such that a safety accident due to the manipulation of the apparatus at the time of driving is prevented in advance, thereby making it possible to remove a risk of a person accident.

In addition, according to the preferred embodiment of the present invention, it is possible to increase convenience of the user by allowing the assistant seat passenger to manipulate the apparatus when the vehicle is being driven.

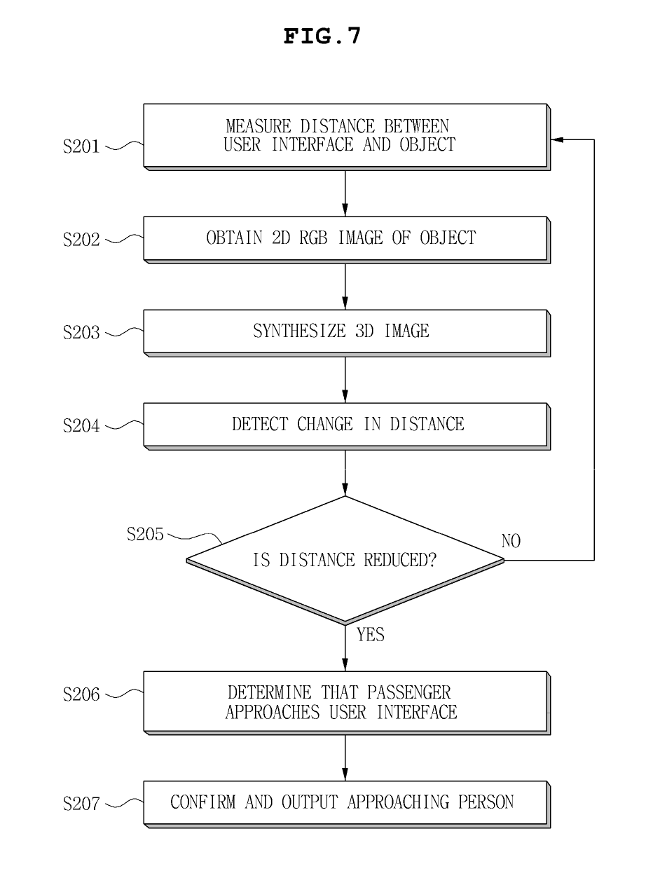

FIG. 7 is a flow chart showing a process of determining whether an assistant seat passenger has approached a user interface of FIG. 6.

Referring to FIG. 7, in the process of determining whether the assistant seat passenger has approached the user interface, a distance between the user interface and an object is first measured by a TOF camera (S201).

Then, a 2D RGB image of an object is photographed by the TOF camera (S202).

Next, a 3D image is synthesized by the TOF camera (S203). The 3D image is synthesized by obtaining the 2D RGB image and reflecting deduced distance information in each pixel contrast value of the 2D RGB image. That is, in the case in which a distance is close, a contrast value of a pixel is raised from an original contrast value of the pixel by a predetermined value, and in the case in which a distance is distant, a contrast value of a pixel is lowered from an original contrast value of the pixel by a predetermined value, such that a final RGBD image having color (RGB) values and a depth (D) value is completed.

Thereafter, an approach determinator detects a change in a distance of the object input to the TOF camera (S204) and determines that a passenger approaches the user interface in order to manipulate menus included in the user interface (S206) in the case in which the distance is gradually reduced (S205).

Then, an approaching person determinator determines a position at which a brightness change is generated in the 3D image input from the TOF camera to determine whether an approaching person is the driver or the assistant seat passenger and provides the determination result to the controlling unit (S207).

Meanwhile, although the preferred embodiment of the present invention has described a method of confirming that the assistant seat passenger approaches the user interface, in the case in which the assistant seat passenger is spaced apart from the user interface, a spaced degree and distance may be determined by confirming whether or not brightness was gradually reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A display apparatus for a vehicle, the display apparatus comprising:
a user interface processing a user input;
a sensing unit sensing movement of the vehicle to output a sensed result and providing approaching person information in the case in which a passenger approaches the user interface within a predetermined distance;
a display unit providing a display screen; and
a controlling unit controlling the display screen of the display unit based on an input through the user interface and changing and providing usable menus according to an approaching person based on the approaching person information provided through the sensing unit when the movement of the vehicle is sensed by the sensing unit.

2. The display apparatus as set forth in claim 1, wherein the sensing unit includes:
a speed sensor measuring and providing a speed of the vehicle in the case in which the vehicle moves; and
a distance sensing sensor providing the approaching person information when the passenger approaches the user interface within the predetermined distance.

3. The display apparatus as set forth in claim 2, wherein the distance sensing sensor includes:
a time of flight (TOF) camera measuring and outputting a distance between the user interface and an object, obtaining a 2-dimensional (2D) RGB image of the object, and synthesizing information on the measured distance with each pixel of the obtained 2D RGB image to generate and output a 3-dimensional (3D) image;
an approach determinator confirming whether an approaching person approaching the user interface within the predetermined distance was generated using a change in the distance between the user interface and the object output from the TOF camera; and
an approaching person determinator confirming a position in the 3D image generated in the TOF camera to determine whether the approaching person is a driver or an assistant seat passenger, thereby providing corresponding approaching person information, in the case in which the generation of the approaching person is confirmed in the approach determinator.

4. The display apparatus as set forth in claim 1, further comprising a digital multimedia broadcasting (DMB) receiving unit receiving DMB broadcasting signals,
wherein the controlling unit provides information received through the DMB receiving unit to the display unit.

5. The display apparatus as set forth in claim 1, further comprising:
a global positioning system (GPS) receiving unit receiving information on a current position; and
a multimedia managing unit managing storage and reproduction of multimedia information,
wherein the controlling unit generates a display content based on information received through the GPS receiving unit and information stored in the multimedia managing unit to provide a display screen to the display unit.

6. The display apparatus as set forth in claim 1, wherein the controlling unit limits the usable menus when the movement of the vehicle is sensed by the sensing unit and then releases some or all of the limited menus when an assistant seat passenger approaches the user interface within the predetermined distance based on the approaching person information provided through the sensing unit.

7. The display apparatus as set forth in claim 1, wherein the controlling unit limits the usable menus when the movement of the vehicle is sensed by the sensing unit and then limits some or all of the usable menus when a driver approaches the user interface within the predetermined distance based on the approaching person information provided through the sensing unit.

8. A method of controlling a display apparatus for a vehicle, the method comprising:
(A) providing, in a controlling unit, a display screen through a display unit in the case in which viewing is requested; and
(B) changing and providing, in the controlling unit, usable menus according to an approaching person based on approaching person information provided through a sensing unit in the case in which movement of the vehicle is sensed by the sensing unit.

9. The method as set forth in claim 8, wherein step A includes:
(A1) determining, in the controlling unit, whether or not DMB broadcasting viewing is requested;
(A2) processing, in the controlling unit, DMB broadcasting data received by a DMB receiving unit in the case in which the DMB broadcasting viewing is requested as a result of the determination; and
(A3) providing, in the controlling unit, the processed DMB broadcasting data as the display screen through the display unit.

10. The method as set forth in claim 8, wherein step (B) includes:
(B1) limiting, in the controlling unit, the usable menus when the movement of the vehicle is sensed by the sensing unit;
(B2) receiving, in the controlling unit, the approaching person information on an approaching person approaching a user interface within a predetermined distance through the sensing unit; and
(B3) releasing, in the controlling unit, the limitation of the menus in the case in which the approaching person information provided through the sensing unit indicates that the approaching person is an assistant seat passenger.

11. The method as set forth in claim 8, wherein step (B) includes:
(B1′) monitoring, in the controlling unit, approach of a passenger to a user interface when the movement of the vehicle is sensed by the sensing unit;
(B2′) receiving, in the controlling unit, the approaching person information on an approaching person approaching a user interface within a predetermined distance through the sensing unit; and
(B3′) limiting, in the controlling unit, the usable menus in the case in which the approaching person information provided through the sensing unit indicates that the approaching person is a driver.

12. The method as set forth in claim 8, wherein a process of providing, in the sensing unit, the approaching person information of step B includes:
(B1″) measuring a distance between a user interface and an object using a TOF camera;
(B2″) obtaining a 2D RGB image of the object using the TOF camera;
(B3″) synthesizing, in the TOF camera, information on the measured distance with each pixel of the obtained 2D RGB image to generate a 3D image;
(B4″) confirming, in an approach determinator, whether the approaching person approaching the user interface within a predetermined distance was generated using a change in brightness of the 3D image generated in the TOF camera; and
(B5″) confirming, in an approaching person determinator, a position in the 3D image generated in the TOF camera to determine whether the approaching person is a driver or an assistant seat passenger, thereby providing corresponding approaching person information, in the case in which the generation of the approaching person is confirmed in the approach determinator.
